(19) United States
(12) Patent Application Publication
(10) Pub. No.: US 2023/0113619 A1
(43) Pub. Date: Apr. 13, 2023

(54) BEARING ARRANGEMENT FOR A SHAFT IN A TURBOCOMPRESSOR

(71) Applicant: Robert Bosch GmbH, Stuttgart (DE)

(72) Inventors: Jochen Wessner, Esslingen (DE); Martin Katz, Stuttgart (DE)

(21) Appl. No.: 17/910,023

(22) PCT Filed: Mar. 9, 2021
(86) PCT No.: PCT/EP2021/055892

§ 371 Date: Sep. 8, 2022

(30) Foreign Application Priority Data
Mar. 12, 2020 (DE) 10 2020 203 204.1

(51) Int. Cl. F04D 29/057; F16C 17/02; F16C 33/74

(52) U.S. Cl. CPC F04D 29/057; F16C 17/02; F16C 33/748; F16C 2210/10; F16C 2360/24; F16C 2380/00

(57) ABSTRACT

The invention relates to a bearing arrangement for a shaft in a turbocompressor having at least one water-fed hydraulic bearing, which is configured to support for rotation an axle of the turbocompressor, wherein the water-fed hydraulic bearing encloses the shaft at a circumference of the shaft to form a bearing gap therebetween; and wherein the water-fed hydraulic bearing is configured to allow water to flow through the bearing gap to support the shaft hydraulically; and two seals, which are designed to seal the bearing gap against the shaft; and wherein gas from the turbocompressor is applied to the two seals outside the bearing gap to seal the bearing.

### BACKGROUND OF THE INVENTION

The invention relates to a bearing arrangement for a shaft in a turbocompressor, which can be a component of a cathode circuit of a fuel cell stack.

Hydrogen-based fuel cells are considered to be the basis for a mobility concept of the future since they emit only water and allow rapid refueling times. For example, PEM (proton exchange membrane) fuel cells can be operated in an electrocatalytic electrode process with oxygen as the oxidizing agent fed to the cathode of the fuel cell and with hydrogen as the fuel supplied to the anode of the fuel cell, in order to provide electrical energy with high efficiency.

Such fuel cells are typically operated in stacked form as a fuel cell stack in a fuel cell system. The air fed to the cathode of the fuel cell stack is compressed by means of a turbocompressor.

### SUMMARY OF THE INVENTION

Support for the drive shaft of such a turbocompressor is implemented either with rolling bearings, with the disadvantage of high friction and a correspondingly short service life, or with hydrodynamic air bearings, which, because of the required high accuracy, are expensive to produce. Both variants likewise have the disadvantage that heat produced in the bearings and/or in the electric machine can be dissipated only with difficulty.

According to one aspect, a bearing arrangement for a shaft of a turbocompressor, a use of the bearing arrangement, a turbocompressor and a cathode circuit of a fuel cell stack are proposed according to the features of the independent claims, and these at least partially achieve the objects described. Advantageous embodiments form the subject matter of the dependent claims and of the following description.

According to one aspect, a bearing arrangement for a shaft of a turbocompressor is proposed, having at least one water-fed hydraulic bearing, which is configured to rotatably support an axle of the turbocompressor, wherein the water-fed hydraulic bearing encloses the shaft at a circumference of the shaft in order to form a bearing gap therebetween. In this case, the water-fed hydraulic bearing is configured to allow water to flow through the bearing gap in order to support the shaft hydraulically. The bearing arrangement has two seals, which are configured to seal the bearing gap with respect to the shaft, and gas from the turbocompressor is applied to the two seals outside the bearing gap in order to seal the bearing.

Such a turbocompressor typically has two turbomachines, which are firmly connected mechanically to a common shaft and can have two such bearing arrangements.

The bearing accuracies of such a water-fed hydraulic bearing in such a bearing arrangement can be significantly reduced by the higher viscosity of water compared to air, and the load-bearing capacity of the bearing increases significantly with similar dimensions.

By virtue of this construction, the heat produced in the bearings can be dissipated with the water, and the water can also be used to dissipate the heat from the electric machine. It is particularly advantageous that a turbocompressor which is arranged in a system of a fuel cell stack can readily provide the water necessary for the water-fed hydraulic bearing, for example by condensation of the air flow emerging from the fuel cell stack.

Application of gas from the turbocompressor to the outside of the respective seal allows greater leaktightness of the bearing arrangement to be achieved. This gas is advantageously automatically available in such a system.

According to one aspect, it is proposed that the respective seal comprises two sealing elements, which define a cavity with the bearing and the shaft; and wherein the bearing has an opening between the two sealing elements in order to fluidically connect the cavity to a water tank.

This makes it possible for water which passes from the bearing gap through a sealing element adjoining the bearing gap to be discharged through the opening, additionally with the aid of the gas of the turbocompressor, as a result of which the bearing is more leaktight. This is additionally assisted by the gas of the turbocompressor, which is applied to the sealing element located further out in relation to the bearing gap. In other words, the compressed air of the turbocompressor is applied to the outer side of the respective outer sealing element, with the result that air flows as a sealing medium into the cavity between the seals via the outer sealing element. This cavity is connected to the tank, which is at a significantly lower pressure level. This ensures that no water gets into regions of the working air gap of the drive machine.

According to one aspect, it is proposed that a gas seal is arranged outside of each of the two seals, with an interspace relative to the respective seal which is configured to seal the bearing gap with respect to the shaft, and the water-fed hydraulic bearing is configured to apply the gas from the turbocompressor to the respective seal outside the bearing gap by means of the interspace.

With such a gas seal arranged outside the seal in relation to the bearing gap, it is possible to carry out the application of the gas of the turbocompressor to the respective seal in a particularly effective way and, if appropriate, to build up a gas pressure.

According to one aspect, it is proposed that the bearing gap is configured to be fluidically connected to a water tank in order to provide water for the bearing gap.

By virtue of this water in the bearing gap, the bearing having the bearing arrangement can be rotatably supported by the water-fed hydraulic bearing.

According to one aspect, it is proposed that the water tank has a pump for pumping water from the water tank into the bearing gap.

If the water-fed hydraulic bearing is embodied as a hydrostatic bearing, such a pump builds up the necessary pressure in the bearing gap. For a hydrodynamic bearing, such a pump can be used, for example, for low-wear starting of the turbocompressor because an initial pressure can be provided by means of the pump.

According to one aspect, it is proposed that the water-fed hydraulic bearing is a hydrodynamic bearing and is configured to automatically draw in water for the bearing gap.

Advantageously, a hydrodynamic bearing does not require any water pressure applied from the outside since it can draw the water out of the tank independently. In the case of a hydrodynamic bearing, the geometry of the bearing is adapted, in particular, in respect of an eccentricity.

According to one aspect, it is proposed that the water flowing out of the bearing arrangement is used to humidify air which is fed to a cathode of a fuel cell system by means of the turbocompressor.

Thus, the water can be fed back to the fuel cell system after it has flowed through the hydrodynamic bearing of the bearing arrangement and/or, if appropriate, also through a cooling-water circuit of the turbocompressor.

According to one aspect, it is proposed that the water flowing out of the bearing arrangement is used to cool components of a fuel cell system.

Since, in addition to the turbocompressor, heat also has to be dissipated from other components of the fuel cell system, such as electronic components, the water can also be used for this purpose.

According to one aspect, it is proposed that the water for the hydrodynamic bearing comprises condensed water of a fuel cell system.

This advantageously means that the water does not have to be carried along but is generated during operation of the fuel cell in order, for example, to be available for cooling purposes. For this purpose, such a fuel cell system can provide a water separator, in particular at the outlet of the cathode side of the fuel cell stack, in which case the separated water of the water separator can then be fed to a water tank.

The invention proposes the use of one of the above-described bearing arrangements for supporting a shaft of a turbocompressor, wherein the turbocompressor is a component of a fuel cell system.

Since, in a fuel cell system of the kind described above, the water is generated during operation, a turbocompressor supported in this way can be used particularly advantageously here.

The proposal is for a turbocompressor having a bearing arrangement of the kind described above, wherein the turbocompressor has a liquid cooling circuit, and the water flowing to and/or from the bearing gap is passed through the liquid cooling circuit in order to dissipate heat from the electric machine of the turbocompressor.

The water required for hydraulic support can be passed through the thermally highly stressed components of the electric machine on the way to the bearing location and can cool them. The drive motor is mounted between the bearing locations, and its components have to be cooled. The water required for hydraulic support can be passed through the thermally highly stressed components of the electric machine on the way to the bearing location and can cool them.

A cathode circuit of a fuel cell stack having a turbocompressor described above, and a humidifier for humidifying the cathode air are proposed, wherein the cathode circuit is configured to feed the water flowing out of the bearing arrangement to the humidifier.

The air mass flow which is delivered by the compressor of the turbocompressor must be humidified and cooled. The water emerging from the water-fed hydraulic bearing can also be used in performing this task.

The cathode gas which is fed to the cathode side of the fuel cell stack has an oxidizing agent for the electrocatalytic reaction of the fuel cells in the fuel cell stack, it being possible, in particular, for the oxidizing agent to comprise oxygen or air.

The water separator can be configured both to separate water in droplet form from the cathode gas and to condense gaseous water. The water separator can, in particular, also be embodied as a condenser or as a combination of a water separator and a condenser. The concept of a water separator thus encompasses both the concept of a water separator per se and the concept of a condenser.

With a water separator embodied in this way, the product, water, of the fuel cell stack, which is operated at different operating points, can be separated out. In particular, if the emerging cathode gas is not saturated with water, is completely saturated, and also if it additionally contains water droplets, for example in the form of mist or water already condensed at another point in the system, this water can be separated out. In this context, such a water separator can have a cyclone and/or a condenser.

In other words, the water separator is configured to receive a gas flow from an electrode space of the fuel cell stack and to separate water from the gas flow when the gas flow is passed through the water separator, the gas flow carrying product water with it from an electrode space of the fuel cell stack.

Thus, the product water, which, as described, forms in large quantities during operation of the fuel cell stack, can be used for further purposes.

According to one aspect, it is proposed that a mobile platform has a turbocompressor with a bearing arrangement of the kind described above.

A mobile platform can be an at least partially automated system that is mobile, and/or can be a driver assistance system. One possible example is an at least partially automated vehicle or a vehicle having a driver assistance system. That is, in this context, an at least partially automated system includes a mobile platform in respect of an at least partially automated functionality, but a mobile platform also includes vehicles and other mobile machines including driver assistance systems. Each of these systems can be a completely or partially autonomous system.

### BRIEF DESCRIPTION OF THE DRAWINGS

Exemplary embodiments of the invention are explained in greater detail below with reference to FIGS. 1 and 2. Here,

FIG. 1 shows a turbocompressor; and

FIG. 2 shows a bearing arrangement for a turbocompressor.

### DETAILED DESCRIPTION

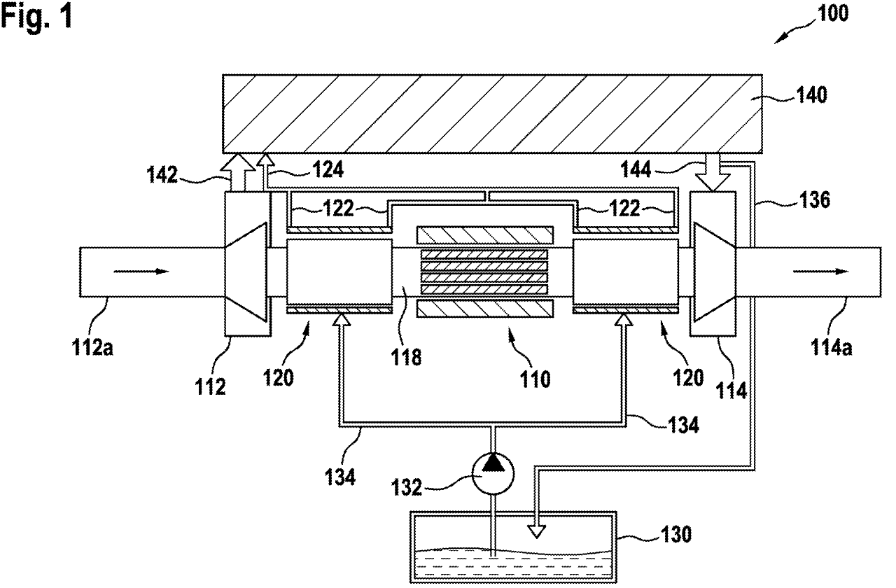

FIG. 1 shows a system 100 having a turbocompressor with water-fed hydraulic bearings 120, a cathode side of a fuel cell stack 140 and a water tank 130. The turbocompressor has a liquid cooling circuit 122, to which the water flowing to and/or from the bearing gap can be fed in order to dissipate heat from the electric machine of the turbocompressor.

At its inlet connection, the cathode side of the fuel cell stack 140 is supplied with air 142 via the compressor stage 112 of the turbocompressor, and, at the outlet connection of the cathode side of the fuel cell stack 140, energy can be recovered from the air mass flow 144 by means of a turbine 114 of the turbocompressor, since both turbomachines are arranged on a common shaft 118.

The common shaft 118 of the turbocompressor is supported with two water-fed hydraulic bearings 120. An electric drive motor 110 is arranged between the bearings, the components of the drive motor generating heat during operation, which must be dissipated.

The water from the water tank 130 can be fed to the water-fed hydraulic bearings 120 via fluid-carrying connecting lines 134 by means of a pump 132. In the case of a hydrostatic water-fed hydraulic bearing 120, pressure is built up in the bearing gap of the bearing, which encloses the shaft at a circumference, by means of this pump 132, ensuring that the shaft 118 of the turbocompressor is rotatably supported.

The water flowing into the bearing 120 flows through the bearing and through the liquid cooling circuit 122, which the turbocompressor has for cooling, and can then be used to feed in the air fed to the cathode side 140 of the fuel cell stack, by means of a feed 124. In this case, this feed 124 can provide the water to a humidifier, which is arranged in the feed of air for the cathode side 41 of the fuel cell stack. Channels of the liquid cooling circuit of the turbocompressor may also be arranged on the pressure side of the bearing arrangement. The water used for the water-fed hydraulic bearings, which can be taken from the water tank 130, can comprise condensed water from the air mass flow 144 of the outlet connection of the cathode side of the fuel cell stack 140. For this purpose, a condenser can be arranged in this air mass flow 144 and this condensed water can be passed into the water tank 130 via a fluid-carrying line 136.

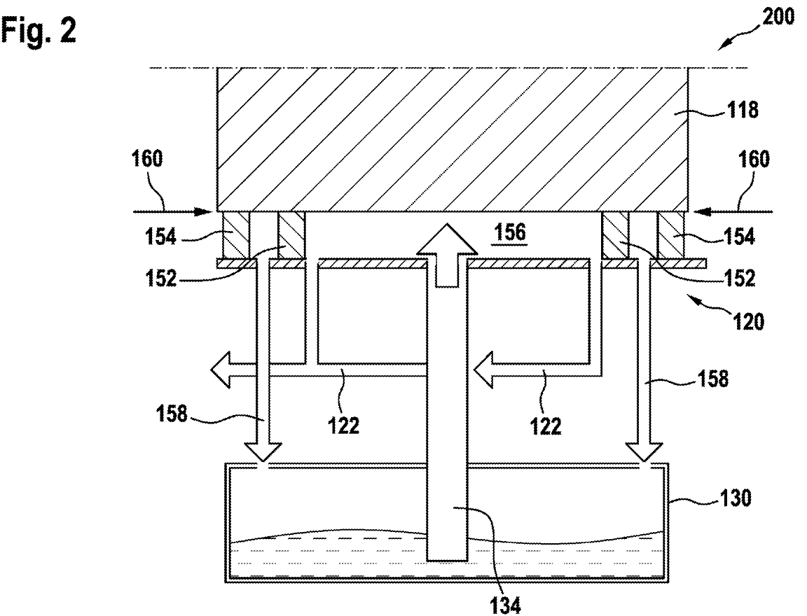

FIG. 2 sketches details of the bearing arrangement 120 in a system 200 which, in addition to the bearing arrangement 120, has the shaft 118 of the turbocompressor and the water tank 130.

In this case, the water from the water tank 130 is passed into the bearing gap 156 by means of a fluid-carrying connecting line 134 in order to build up there the pressure necessary to support the shaft 118 of the turbocompressor, either by means of the rotating shaft 118, in the case of a hydrodynamic bearing, or by means of a pump 132, which is arranged in the connecting line 134. As described above, this water which is passed through the bearing gap 156 can be fed either to the cathode air flow 142 and/or to the liquid cooling circuit 122 of the turbocompressor via the connection line 122, which are connected to openings of the bearing in the region of the bearing gap 156.

The bearing gap 156 is sealed by means of two seals, each of which has two sealing elements 152, 154. In this case, gas from the turbocompressor is applied to the respective sealing element 154 which is located further out in order to seal the bearing.

Between the two sealing elements 152, 154, which are spaced apart from one another in order to form a cavity with the shaft 118, an opening is provided which, by means of a fluid-carrying connection 158, conducts any water entering this cavity into the water tank 130. Since gas from the turbocompressor is applied to the outer sealing element 154 of the respective seal, water which passes through the sealing element 152 located further inward is passed through the opening of the cavity between the two sealing elements 152, 154 into the water tank 130. This leads to particularly good sealing of the bearing arrangement, which is particularly important in ensuring that the water of the water-fed hydraulic bearing does not get into the turbine so as to avoid droplet impingement.

1. A bearing arrangement (200) for a shaft (118) in a turbocompressor, the bearing arrangement having:
at least one water-fed hydraulic bearing (120), which is configured to rotatably support an a shaft (118) of the turbocompressor, wherein the water-fed hydraulic bearing (120) is configured to enclose the shaft (118) at a circumference of the shaft (118) in order to form a bearing gap (156) therebetween; and wherein the water-fed hydraulic bearing (120) is configured to allow water to flow through the bearing gap (156) in order to support the shaft (118) hydraulically; and
two seals, which are configured to seal the bearing gap (156) with respect to the shaft (118), when gas from the turbocompressor is applied to the two seals outside the bearing gap (156) in order to seal the bearing (120).

2. The bearing arrangement (200) as claimed in claim 1, wherein each of the two seals comprises two sealing elements (152, 154), which define a cavity with the bearing (120) and the shaft (118); and wherein the bearing (120) has an opening between the two sealing elements (152, 154) in order to fluidically connect the cavity to a water tank (130).

3. The bearing arrangement (200) as claimed in claim 1 , wherein a gas seal is arranged outside of each of the two seals, with an interspace relative to the respective seal which is configured to seal the bearing gap (156) with respect to the shaft (118), and the water-fed hydraulic bearing (120) is configured to apply the gas from the turbocompressor to the respective seal outside the bearing gap (156) by means of the interspace.

4. The bearing arrangement (200) as claimed in claim 1 ,wherein the bearing gap (156) is configured to be fluidically connected to a water tank (130) in order to provide water for the bearing gap (156).

5. The bearing arrangement (200) as claimed in claim 4, wherein the water tank (130) has a pump (132) for pumping water from the water tank (130) into the bearing gap (156).

6. The bearing arrangement (200) as claimed in claim 1 , wherein the water-fed hydraulic bearing (120) is a hydrodynamic bearing and is configured to automatically draw in water for the bearing gap (156).

7. The bearing arrangement (200) as claimed in claim 1 , wherein the water flowing out of the bearing arrangement (200) is used to humidify air which is fed to a cathode of a fuel cell system by means of the turbocompressor.

8. The bearing arrangement (200) as claimed in claim 1 , wherein the water flowing out of the bearing arrangement (200) is used to cool components of a fuel cell system.

9. The bearing arrangement (200) as claimed in claim 1 , wherein the water for the hydrodynamic bearing comprises condensed water of a fuel cell system.

10. (canceled)

11. (canceled)

12. (canceled)

13. A turbocompressor comprising
a shaft (118) having a circumference,
an electric machine,
a liquid cooling circuit (122), and
a bearing arrangement (200) having
at least one water-fed hydraulic bearing (120), which rotatably supports the shaft (118) of the turbocompressor, wherein the water-fed hydraulic bearing (120) encloses the shaft (118) at the circumference of the shaft (118) in order to form a bearing gap (156) therebetween; and wherein the water-fed hydraulic bearing (120) is configured to allow water to flow through the bearing gap (156) in order to support the shaft (118) hydraulically, and
two seals, which seal the bearing gap (156) with respect to the shaft (118),
wherein gas from the turbocompressor is applied to the two seals outside the bearing gap (156) in order to seal the bearing (120), and
wherein the water flowing to and/or from the bearing gap (156) is passed through the liquid cooling circuit (122) in order to dissipate heat from the electric machine of the turbocompressor.

14. The turbocompressor as claimed in claim 13, wherein each of the two seals comprises two sealing elements (152, 154), which define a cavity with the bearing (120) and the shaft (118); and wherein the bearing (120) has an opening between the two sealing elements (152, 154) in order to fluidically connect the cavity to a water tank (130).

15. The turbocompressor as claimed in claim 13, wherein a gas seal is arranged outside of each of the two seals, with an interspace relative to the respective seal which is configured to seal the bearing gap (156) with respect to the shaft (118), and the water-fed hydraulic bearing (120) is configured to apply the gas from the turbocompressor to the respective seal outside the bearing gap (156) by means of the interspace.

16. The turbocompressor as claimed in claim 13, wherein the bearing gap (156) is configured to be fluidically connected to a water tank (130) in order to provide water for the bearing gap (156).

17. The turbocompressor as claimed in claim 16, wherein the water tank (130) has a pump (132) for pumping water from the water tank (130) into the bearing gap (156).

18. The turbocompressor as claimed in claim 13 wherein the water-fed hydraulic bearing (120) is a hydrodynamic bearing and is configured to automatically draw in water for the bearing gap (156).

19. The turbocompressor as claimed in claim 13, wherein the water flowing out of the bearing arrangement (200) is used to humidify air which is fed to a cathode of a fuel cell system by means of the turbocompressor.

20. The turbocompressor as claimed in claim 13, wherein the water flowing out of the bearing arrangement (200) is used to cool components of a fuel cell system.

21. The turbocompressor as claimed in claim 13, wherein the water for the hydrodynamic bearing comprises condensed water of a fuel cell system.

22. A cathode circuit of a fuel cell stack having a turbocompressor as claimed in claim 13, and a humidifier for humidifying the cathode air, wherein the cathode circuit is configured to feed the water flowing out of the bearing arrangement (200) to the humidifier.
